(19) United States
(12) Patent Application Publication
(10) Pub. No.: US 2019/0193155 A1
(43) Pub. Date: Jun. 27, 2019

(54) SEAL AND A BUILD TANK

(71) Applicant: ARCAM AB, Moelndal (SE)

(72) Inventor: Stefan Olausson, Goeteborg (SE)

(21) Appl. No.: 16/188,487

(22) Filed: Nov. 13, 2018

Related U.S. Application Data
(60) Provisional application No. 62/608,899, filed on Dec. 21, 2017.

(51) Int. Cl. B22F 3/105; B33Y 30/00; B33Y 50/02

(52) U.S. Cl. CPC B22F 3/1055; B33Y 30/00; B22F 2301/205; B22F 2003/1056; B22F 2301/052; B33Y 50/02

(57) ABSTRACT

Provided is a seal (19) for sealing against powder between a cylinder (14) of a build tank (5) and a build table (9) arranged in the cylinder of an additive manufacturing apparatus (1) for forming a three-dimensional article layer by layer from a powder. The seal (19) has an endless ring portion (21) for extending along a circumference of an inner surface (20) of the cylinder (14) and abutting against the inner surface (20).

### CROSS REFERENCE TO RELATED APPLICATIONS

This application claims benefit of U.S. Provisional Patent Application No. 62/608,899, filed on Dec. 21, 2017, the contents of which as are hereby incorporated by reference in their entirety.

### BACKGROUND

Freeform fabrication or additive manufacturing (AM) using electron beam melting (EBM) or laser beam melting is a method for forming a solid three-dimensional article from a powder. The three-dimensional article is formed layer by layer by successive fusion of selected areas of powder layers, which selected areas correspond to successive layers of the three-dimensional article. A layer of powder, such as metal powder, is deposited on a build area and an electron beam or a laser beam is used to selectively melt the powder layer of the build area. The melted material fuses with underlaying layers and solidifies to form the top layer of the solid three-dimensional article. A further layer of powder is deposited onto the previous layer, and the electron or laser beam is used to selectively melt the further powder layer of the build area. The melted material solidifies and form another solid layer fused onto the previous solid layer. This process is repeated for multiple layers until the desired 3D geometry of the article is achieved.

An apparatus for forming such a three-dimensional article has a build table on which the three-dimensional article is to be formed, a powder distributor device for delivering powder to the build table (build area) for the formation of the powder layers and an electron beam source or a laser beam source for providing the energy beam used for melting the powder. The build table is arranged in a build tank which in turn is arranged in a build chamber formed by a casing. When using EBM, the build chamber is a vacuum chamber.

The build table is usually displaceable relative to the build tank in the vertical direction for maintaining the level of the top surface of the build layer (powder bed) when adding powder layers. During the build process the powder applied should be prevented from moving from the build area of the build table to a position under the build table. For avoiding such powder leakage between the build tank and the build table, a seal can be arranged on the periphery of the build table. For high temperature powder, such seals made from a ceramic material in form of a rope will however often require a plurality of rounds of the rope around the build table for achieving the sealing function. Further, under unfavourable conditions particles from the ceramic rope can pollute the metal powder used for the build process.

### BRIEF SUMMARY

Having this background, an object of the invention is to provide a seal for a build tank of an additive manufacturing apparatus for forming a three-dimensional article layer by layer from a powder, by which seal the sealing performance can be improved and any pollution of the powder used in the build process by particles from the seal can be reduced.

The objective is achieved by a seal for sealing against powder between a cylinder of a build tank and a build table arranged in the cylinder of an additive manufacturing apparatus for forming a three-dimensional article layer by layer from a powder, wherein the seal has an endless ring portion for extending along a circumference of an inner surface of the cylinder and abutting against the inner surface.

By the expression “endless ring portion” is meant a continuous ring portion extending 360° without any interruption such as a break or gap, i.e. forming a closed loop. By “cylinder” is meant a body having a cylinder-shaped cavity. Preferably the ring portion is substantially circular, and the cylinder is a substantially circular cylinder, although other ring portion-cylinder combinations are possible, such as an oval or elliptic ring portion and cylinder.

According to one embodiment of the seal, the ring portion forms a flexible flange having an outer peripheral edge for abutting against the inner surface of the cylinder. Good sealing performance can be achieved when using a relative thin flexible flange. The flange suitably has a length in a radial direction of the flange and a thickness, where the radial length of the flange is 10-200 times, preferably 20-100 times the flange thickness. By flange thickness is meant an average thickness of the flange. The thickness of the flange can often be in order of 0.1 to 1 mm.

According to another embodiment of the seal, the flange is tapered with a decreasing thickness towards the outer peripheral edge. Hereby, a flexible flange can be achieved at the same time as both a sharp outer peripheral edge and the requisite strength of the flange can be achieved.

According to a further embodiment of the seal, the outer peripheral edge of the flange has a radius R in the range 0<R<100 μm, preferably R is in the range 0<R<50 μm. Good sealing performance can be achieved for an edge radius smaller than the grain size of the powder used for the build process.

According to a further embodiment of the seal, the ring portion is conical with a first end for sealing against the inner surface of the cylinder, and a second end, wherein the first end has an outer dimension, preferably diameter, exceeding an outer dimension, preferably diameter, of the second end. Hereby, the seal can be manufactured in an efficient way.

The ring portion can be manufactured for example by spin-forming of a sheet metal. The ring portion is mechanically connected to the build table. Preferably, the seal has a further attachment part, such as a ring-shaped plate or sheet, connected to the second end of the ring portion which attachment part is mechanically connected to the build table. The ring portion and the attachment part are suitably made in one piece. This attachment part can be connected to a radial or axial surface of the build table such that the seal will protrude from the build table and follow an axial movement of the build table.

According to a further embodiment of the seal, the ring portion is made of a metal material, preferably titanium or aluminium. Such a metal material gives good sealing performance at the same time as any particles given off from the seal will have minor impact on the build powder and the product produced from the powder, particularly if the powder is a metal powder.

A further objective of the invention is to provide a build tank for an additive manufacturing apparatus for forming a three-dimensional article layer by layer from a powder, by which build tank the sealing performance can be improved, and any pollution of the powder used in the build process by particles from the seal can be reduced.

This objective is achieved by a build tank for an additive manufacturing apparatus for forming a three-dimensional article layer by layer from a powder, wherein the build tank comprises a cylinder and a build table arranged inside the cylinder which build table is displaceable relative to the cylinder in an axial direction of the cylinder, and the build table divides the cylinder in an upper space and a lower space and has a surface facing towards the upper space for receiving powder, wherein the build tank further comprises a seal mechanically connected to the build table for sealing between an inner surface of the cylinder and the build table for preventing powder from being moved from the upper space to the lower space, and the seal has an endless ring portion extending along a circumference of the inner surface and abutting against the inner surface of the cylinder.

According to one embodiment of the build tank, an outer dimension, preferably diameter, of the ring portion exceeds an inner dimension, preferably diameter, of the cylinder before the seal is arranged in the cylinder such that the ring portion is compressed and pre-tensioned when the seal is arranged in the cylinder. For example, the outer dimension is an outer diameter of the ring portion and the inner dimension is an inner diameter of the cylinder, wherein the outer diameter of the ring portion is in the interval 1.0005 to 1.02 times the inner diameter of the cylinder before the seal is arranged in the cylinder, and preferably 1.001 to 1.01 times the inner diameter of the cylinder before the seal is arranged in the cylinder.

Hereby, the sealing function can be improved. In operation, the surface of the ring portion in contact with the cylinder can be sharpened by wear which further improves the sealing function. In addition, the manufacture of the seal can be facilitated since a wider tolerance range can be applied.

According to another embodiment of the build tank, the seal is mechanically connected to the build table such that the seal will follow a displacement motion of the build table in the axial direction of the cylinder, and such that the seal is floating relative to the build table in a radial direction of the cylinder for centring the ring portion relative to the cylinder by the inner surface of the cylinder.

Hereby, the seal will be self-centring which means that even if the build table would not be perfectly centred relative to the cylinder, the seal is always centred relative to the cylinder.

According to a further embodiment of the build tank, the ring portion forms a flexible flange protruding from the build table, where the flange has an outer peripheral edge abutting against the inner surface of the cylinder, and preferably the flange is angled relative to a radial direction of the cylinder such that in a radial direction along the flange towards the outer peripheral edge, the flange has a first extension direction component in parallel with the radial direction of the cylinder which first direction component points towards the inner surface of the cylinder, and a second direction component in parallel with the axial direction of the cylinder which second direction component points upwards. For example, the flange may form an angle α relative to the radial direction of the cylinder, where a is in the range 30°<α<90°, preferably α is in the range 45°<α<90°.

The angled flange can give an improved sealing performance. By choosing the angle as mentioned above, the sealing performance can be further improved since a favourable contact force between the cylinder and the flange can be achieved.

Features already described with reference to the seal per se are not repeated for the build tank since the advantages are similar or the same.

Further advantages and advantageous features of the invention are disclosed in the following description and in the claims provided herein.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic view of an AM apparatus having a build tank,

FIG. 2A is a schematic cut view of a build tank with a cylinder, a build table arranged in the cylinder and a seal arranged for sealing between the cylinder and the build table,

FIG. 2B is a view of the seal in FIG. 2A,

FIG. 2C is an enlarged view of a part of the seal in FIG. 2A,

FIG. 3A is a perspective top view showing the build table and the seal in FIG. 2A,

FIG. 3B is a perspective view from below showing the seal in FIG. 2A,

FIG. 4 is a cut perspective view showing one embodiment of the seal arranged on a build table,

FIG. 5 is a cut perspective view showing a variant of the seal in FIG. 4,

FIG. 6 is a cut perspective view of a further embodiment of the seal arranged on a build table,

FIG. 7 is a block diagram of an exemplary system according to various embodiments,

FIG. 8A is a schematic block diagram of an exemplary server according to various embodiments, and

FIG. 8B is a schematic block diagram of an exemplary mobile device according to various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Still further, to facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “three-dimensional structures” and the like as used herein refer generally to intended or actually fabricated three-dimensional configurations (e.g., of structural material or materials) that are intended to be used for a particular purpose. Such structures, etc. may, for example, be designed with the aid of a three-dimensional CAD system.

The term “electron beam” as used herein in various embodiments refers to any charged particle beam. The sources of charged particle beam can include an electron gun, a linear accelerator and so on.

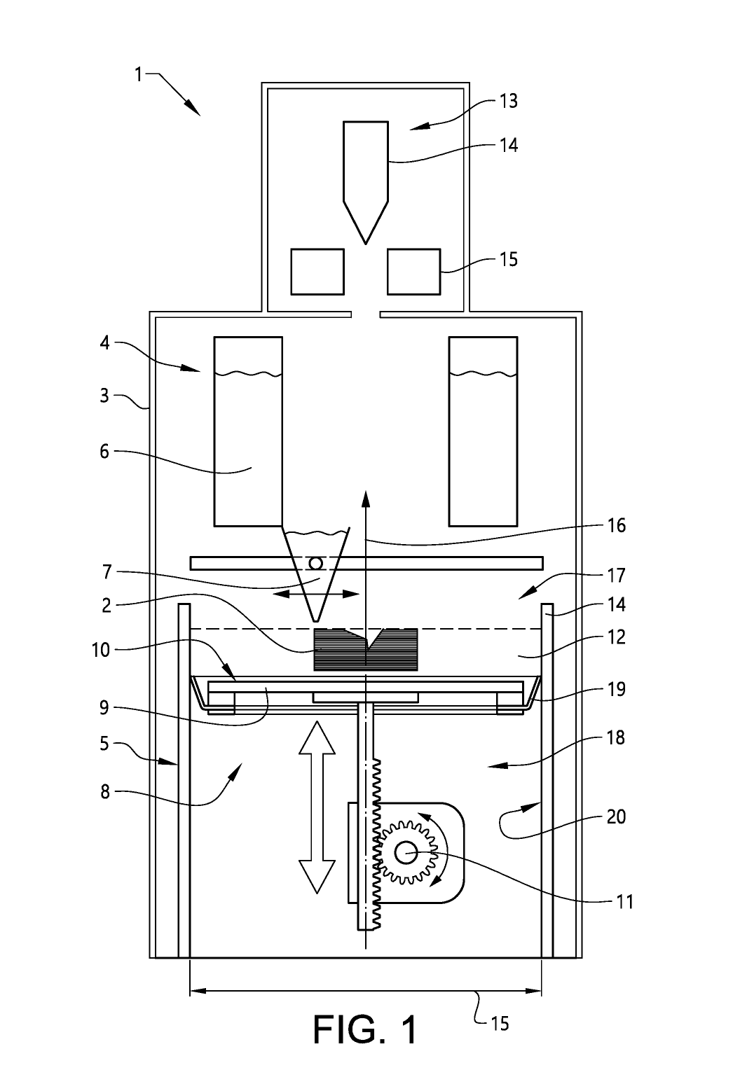

FIG. 1 shows an apparatus 1 for forming a three-dimensional article 2 layer by layer by successive fusion of selected areas of a powder layers, which selected areas correspond to successive layers of the three-dimensional article. The apparatus 1 comprises an outer casing 3 forming a build chamber 4, and a build tank 5 arranged inside the casing 3 in the build chamber 4.

Further, the apparatus 1 comprises a powder hopper 6 and a powder distributor device 7 and a platform device 8 having a build table 9 for receiving powder from the powder distributor device 7. The build table 9 is arranged inside the build tank 5. The build table 9 has a top surface 10 for receiving powder from the powder distributor device 7. The top surface 10 of the build table 9 is preferably flat and horizontal and is faced upwardly in a vertical direction.

The platform device 8 comprises means 11 for movement of the build table 9 relative to the build tank 5 in the vertical direction, such as a servo motor equipped with a gear, adjusting screws, etc. The powder distributor device 7 is arranged to lay down a thin layer of the powder material on the build plate or powder bed 12 in the build tank 5. During a work cycle the build table 9 will be lowered for maintaining the position of the top surface of the powder bed relative to the build tank 5 when adding powder layers to the powder bed 12.

The apparatus 1 has an energy beam source 13 arranged for creating an energy beam. The energy beam is used for melting the selected areas of the powder. The energy beam is scanned over the surface of the current powder layer for melting the selected areas. The selected areas of each layer can be based on a model dividing the article to be manufactured in successive layers or slices. The model may be a computer model generated by a CAD (Computer Aided Design) tool.

In the example embodiment illustrated in FIG. 1, the energy beam source is an electron beam source 13. The electron beam source can be designed in a way well known to the person skilled in the art. The electron beam source may have an electron gun 14 with an emitter electrode which is connected to a high voltage circuit and a current source for accelerating electrons and releasing electrons from the emitter electrode. These electrons form the electron beam. The electron beam source has also focusing coils and deflection coils 15 for directing the electron beam to various positions of the build layer surface.

The build chamber 4 can be arranged for maintaining a vacuum environment by means of a vacuum system, which may comprise a turbomolecular pump, a scroll pump, an ion pump and one or more valves. Such a vacuum system is known to the person skilled in the art and is not further described or illustrated herein.

In another embodiment of the apparatus, any other suitable energy beam source can be used. For example, a laser beam source. The laser beam source can be designed in a way well known to the person skilled in the art. The laser beam source may have a laser emitter for emitting photons. These photons form the laser beam. The laser beam source has also focusing units and deflection units for directing the laser beam to various positions of the build layer surface. The focusing units can comprise lenses and the deflection units can comprise mirrors.

The build tank 5 comprises a cylinder 14 and the build table 9 is arranged inside the cylinder 14. The cylinder 14 is a body having a cylinder-shaped cavity for receiving the build table 9, preferably a substantially circular cylinder with an inner diameter 15. Optionally, the outer peripheral surface of the cylinder 14 can also be circular cylinder-shaped. The build table 9 is displaceable relative to the cylinder 14 in an axial direction 16 of the cylinder 14. The build table 9 dividing the cylinder 2 in an upper space 17 and a lower space 18. The top surface 10 is faced towards the upper space 17 for receiving powder. The shape of the build table 9 is suitably adapted to the cylinder shape.

The build tank further comprises a seal 19 for sealing against powder between the cylinder 14 of the build tank 5 and the build table 9 arranged in the cylinder 14. The seal is mechanically connected to the build table 9 for sealing between an inner surface 20 of the cylinder 14 and the build table 9 for preventing powder from being moved from the upper space 17 to the lower space 18.

By mechanical connection is meant both connections allowing the seal to move somewhat relative to the build table and connections where the seal is fixed relative to the build table. Further, the seal can be connected by means of a bolted joint, welding, press fitting or other suitable means.

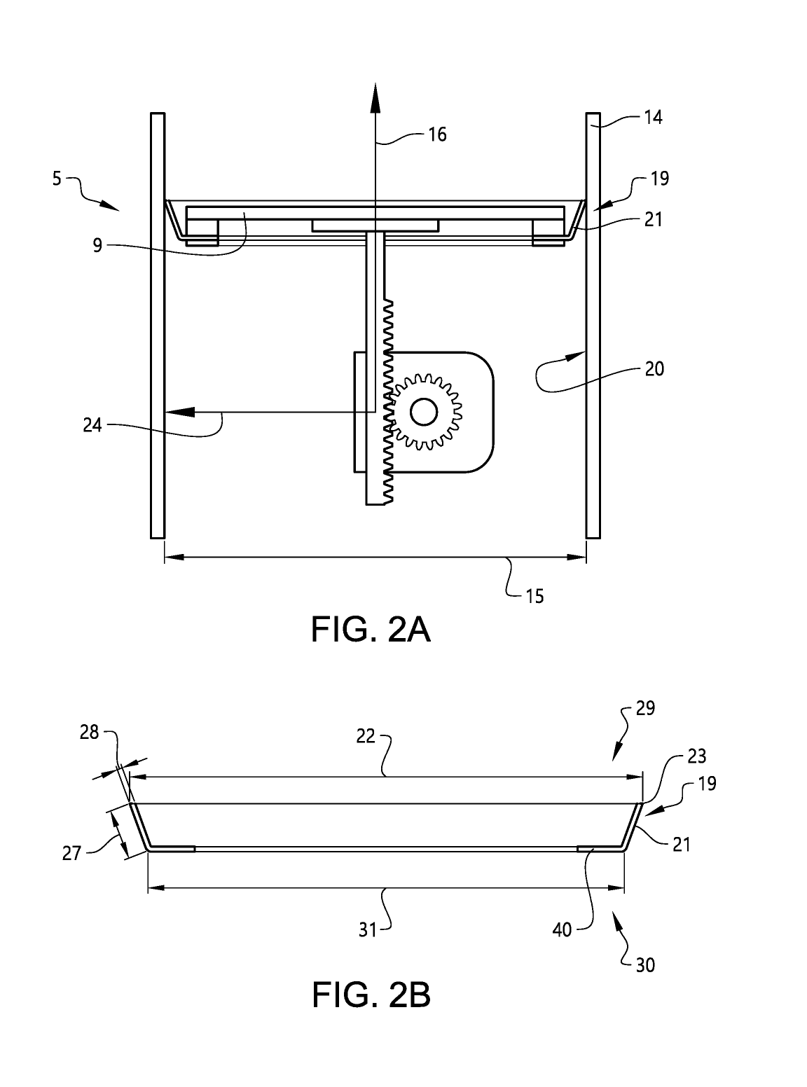

FIG. 2A shows the cylinder 14 and the build table 9 of the build tank 5 in a cross-section view, and FIG. 2B shows the seal 19 also shown in FIG. 2A. The seal 19 has an endless ring portion 21 for extending along a circumference of the inner surface 20 of the cylinder 14 and abutting against the inner surface 20.

Thus, when the seal 19 is mounted on the build table and arranged in the cylinder, the ring portion 21 extends along a circumference of the inner surface 20 of the cylinder 14 and abuts against the inner surface 20. The endless ring portion 21 has an outer dimension, preferably a diameter 22. In the example embodiment illustrated in FIGS. 2A and 2B, the outer diameter 22 of the ring portion 21 exceeds the inner diameter 15 of the cylinder 14 before the seal 19 is arranged in the cylinder 14 such that the ring portion 21 is compressed and pre-tensioned when the seal 19 is arranged in the cylinder 14.

The outer diameter 22 of the ring portion 21 is suitably 1.0005 to 1.02 times the inner diameter 15 of the cylinder 14 before the seal 19 is arranged in the cylinder 14, and preferably the outer diameter 22 is 1.001 to 1.01 times the inner diameter 15.

As appears from FIG. 2B for instance, the ring portion can form a flexible flange 21 having an outer peripheral edge 23 for abutting against the inner surface 20 of the cylinder 14. The flexible flange 21 can protrude from the build table 9, optionally via another portion of the seal 19, and abut against the inner surface 20 of the cylinder 14. In the example embodiment illustrated in FIG. 2B, the seal 19 has an inner ring 40 connected to the flange 21. Preferably, the flange 21 and the inner ring 40 is made in one piece. The inner ring 40, such as a plate or sheet, is arranged to extend substantially in the radial direction 24 of the cylinder and is used for mechanically connecting the seal 19 to the build table 9.

The flange 21 has a length 27 in a radial direction of the flange and a thickness 28. Although depending on the material of the flange, the radial length 27 of the flange 21 is suitably 10-200 times, preferably 20-100 times the flange thickness 28, for achieving the flexibility required. In case the flange thickness is not uniform, by flange thickness is meant the average thickness of the flange. The flange thickness can often be in order of 0.1 to 1 mm.

Further with reference to FIG. 2B, the ring portion 21 can be conical having a first end 29 with a first outer dimension, preferably the outer diameter 22, of the ring portion 21, and a second end 30 with a second outer dimension, preferably a diameter 31, of the ring portion 21, which second outer dimension is smaller than the first outer dimension. The conical ring portion 21 is arranged in the cylinder 14 with the first end 29 facing upwards and the second end 30 facing downwards. In other words; in FIG. 2A the first end 29 is arranged above the second end 30 of the ring portion 21.

As illustrated in FIG. 2C, the flange 21 can be tapered with a decreasing thickness towards the outer peripheral edge 23.

Further, the outer peripheral edge 23 of the flange 21 has suitably a radius R in the range 0<R<100 μm, preferably 0<R<50 μm. Although the radius R has to be adapted to the build powder grain size, a radius of the outer peripheral edge 23 in the interval 5-100 μm will often work well.

Further with reference to FIG. 2C, the flange 21 can be angled relative to a radial direction 24 of the cylinder 14 such that in a radial direction along the flange 21 towards the outer peripheral edge 23, the flange 21 has a first extension direction component 25 in parallel with the radial direction 24 of the cylinder 14 which first direction component 25 points towards the inner surface 20 of the cylinder 14, and a second direction component 26 in parallel with the axial direction 16 of the cylinder 14 which second direction component 26 points upwards.

The flange can form an angle α relative to the radial direction 24 of the cylinder 14, where α is in the range 30°<α<90°, preferably in the range 45°<α<90°, and often in the interval 50-85°.

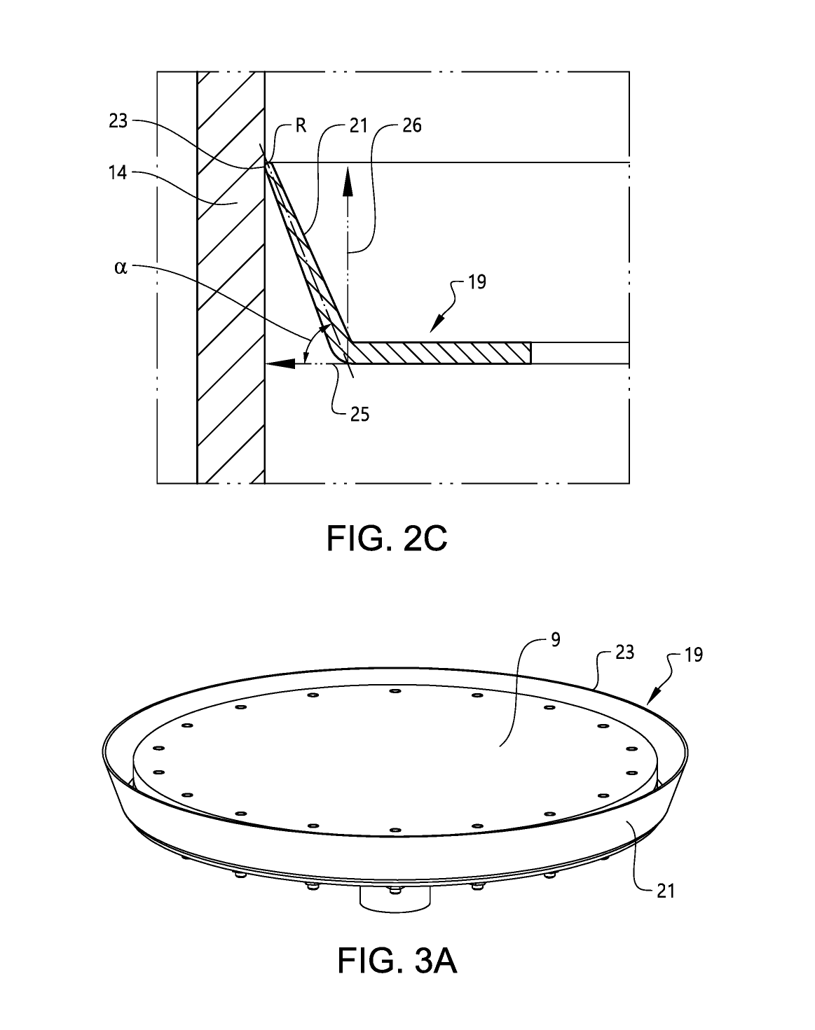

FIG. 3A shows the seal 19 mounted on the build table 9 in a perspective top view. The endless ring portion 21 provided with the outer peripheral edge 23 extends around the build table 9 as previously described. Thus, in the example embodiment illustrated in FIGS. 2A and 3A, the seal 19 is designed as a circular ring comprising a ring portion in the form of an upwardly angled flange 21 and an inner ring 40 for mechanically connecting the seal 19 to the build table 9.

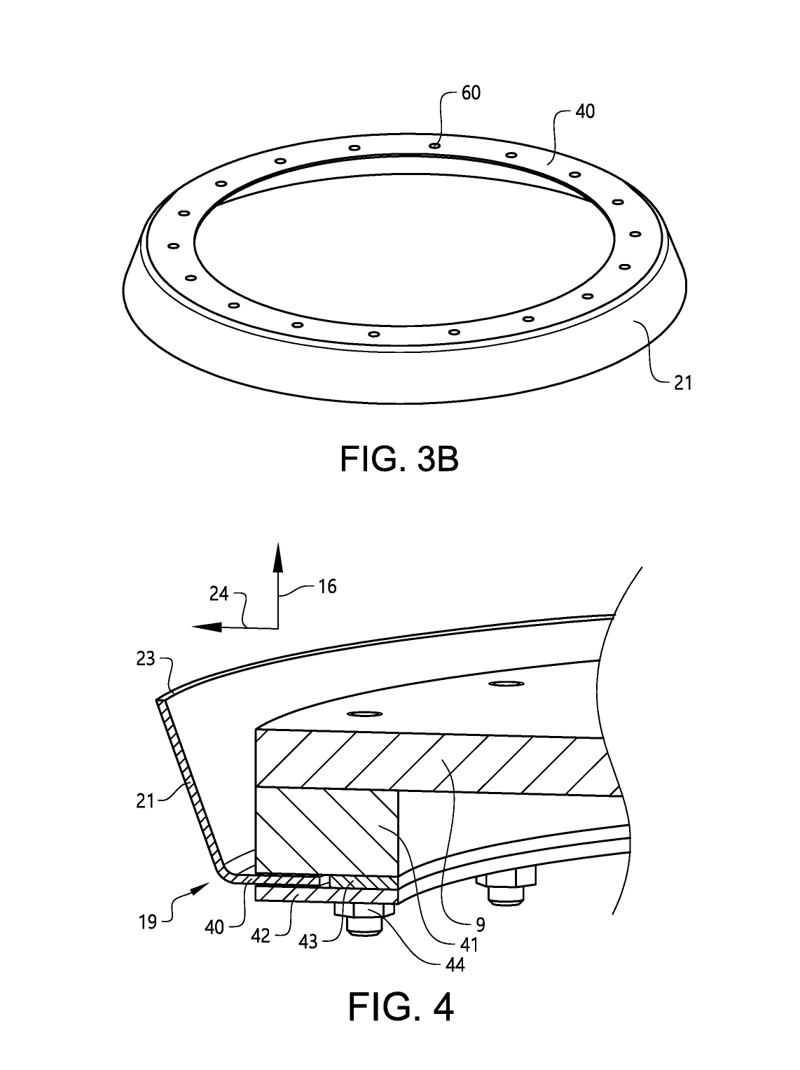

FIG. 3B shows the seal in FIG. 3A in a perspective view from below. The ring portion 21 and the inner ring 40 having through holes 60 for attachment to the build table 9 are illustrated. The through holes 60 can be excluded in case another mechanical connection is used, for example if the seal 19 is arranged to be “floating” relative to the build table 9 as will be described hereinafter with reference to FIG. 4.

FIG. 4 shows in a cut perspective view how the seal 19 can be mechanically connected to the build table 9. In this example embodiment the seal 19 is mechanically connected to the build table 9 such that the seal 19 will follow a displacement motion of the build table 9 in the axial direction 16 of the cylinder 14, and such that the seal 19 is floating relative to the build table 9 in the radial direction 24 of the cylinder 14 for centering the ring portion 21 relative to the cylinder 14 by the inner surface 20 of the cylinder 14. See also FIG. 2A.

In addition to the flange portion 21, the seal 19 preferably has the inner ring in form of an attachment part 40 such as a ring-shaped plate or sheet, which attachment part 40 is connected to the second end 30 of the ring portion 21, and which attachment part 40 is mechanically connected to the build table 9. The ring portion 21 and the attachment part 40 are preferably made in one piece. The attachment part 40 can be connected to a radial or axial surface of the build table 9 such that the seal 19 will protrude from the build table 9 and follow an axial movement of the build table 9.

In the example embodiment illustrated in FIG. 4, the attachment part 40 of the seal is arranged between an upper plate 41 and a lower plate 42. A further intermediate plate 43 is also arranged between the upper plate 41 and the lower plate 42. The intermediate plate 43 is arranged beside the attachment part 40 at a different radial position. Further, the upper plate 41 and lower plate 42 are mounted to each other by means of a bolted joint 44. The intermediate plate 43 has a somewhat larger thickness than the attachment part 40 of the seal 19 and is clamped between the upper plate 41 and the lower plate 42. Thus, a small axial clearance will allow the attachment part 40 and thus the seal 19 to adjust in the radial direction 24 of the cylinder 14, i.e. the seal 19 is floating in the radial direction 24, whereas the seal 19 is mechanically connected to the build table 9 for moving with the build table 9 in the axial direction 16 of the cylinder 14.

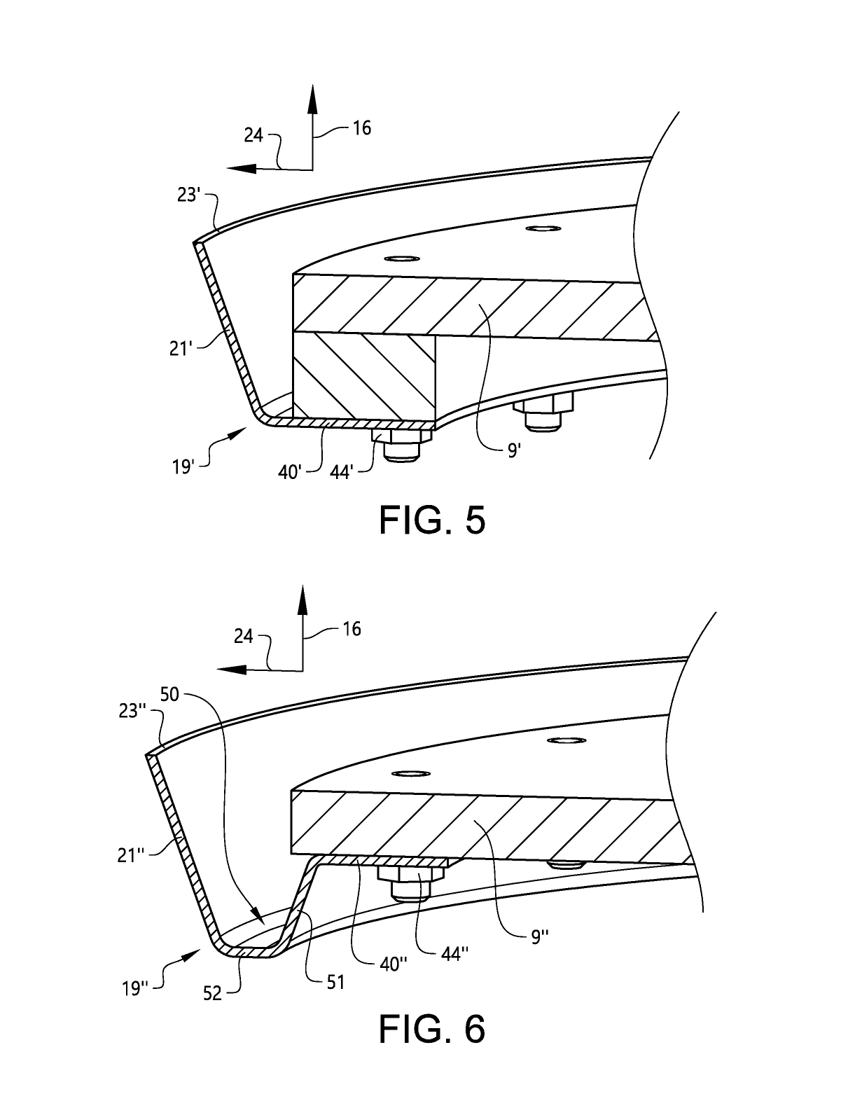

FIG. 5 shows a variant of the seal in FIG. 4 where the seal 19′ is fixed relative to the build table 9′, both in the radial direction 24 and the axial direction 16, by means of a bolted joint 44′ extending through the attachment part 40′ of the seal 19′ and the build table 9′.

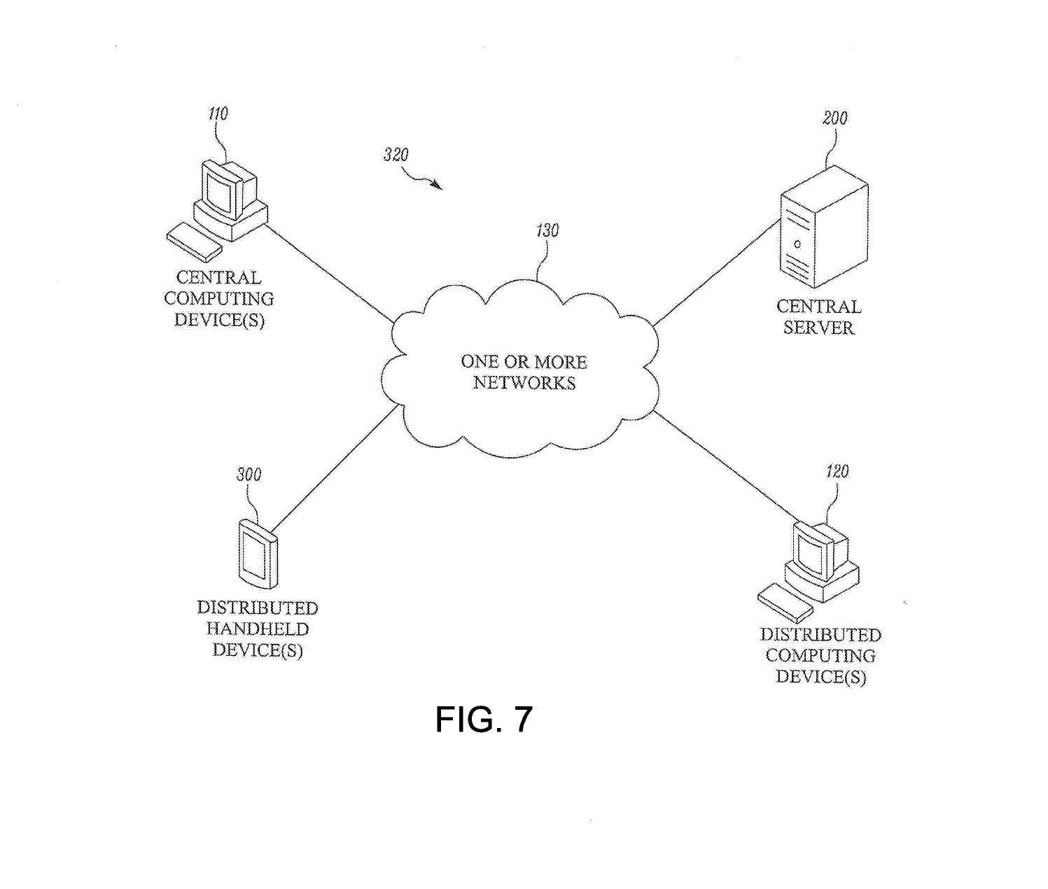

FIG. 6 shows another embodiment of the seal 19″. The seal 19″ has the attachment part 40″ for mechanical connection to the build table 9″ and the ring portion 21″ for contacting the inner surface 20 of the cylinder 14. In addition, the seal 19″ has an inner flange portion 50 connecting the attachment part 40″ and the flange 21″. The inner flange portion 50 can have a first part 51 extending downwardly from the build table 9 and a second part 52 extending radially from the first part 51 to the flange 21″. This design forming a V- or U-shaped cross-section of the seal 19″ can increase the flexibility of the seal 19″. Further, also in this example embodiment, the seal 19″ can be arranged fixed relative to the build table or in a way such that the seal is floating in the radial direction as previously described.

In another aspect of the invention it is provided a program element configured and arranged when executed on a computer to implement a method as described herein. The program element may be installed in a computer readable storage medium. The computer readable storage medium may be any type of control unit, as commonly known in the art, as may be desirable. The computer readable storage medium and the program element, which may comprise computer-readable program code portions embodied therein, may further be contained within a non-transitory computer program product. Further details regarding these features and configurations are provided, in turn, below.

As mentioned, various embodiments of the present invention may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAIVI), phase-change random access memory (PRAM), ferroelectric random-access memory (FeRAM), non-volatile random-access memory (NVRAM), magnetoresistive random-access memory (MRAIVI), resistive random-access memory (RRAIVI), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like, as have been described elsewhere herein. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

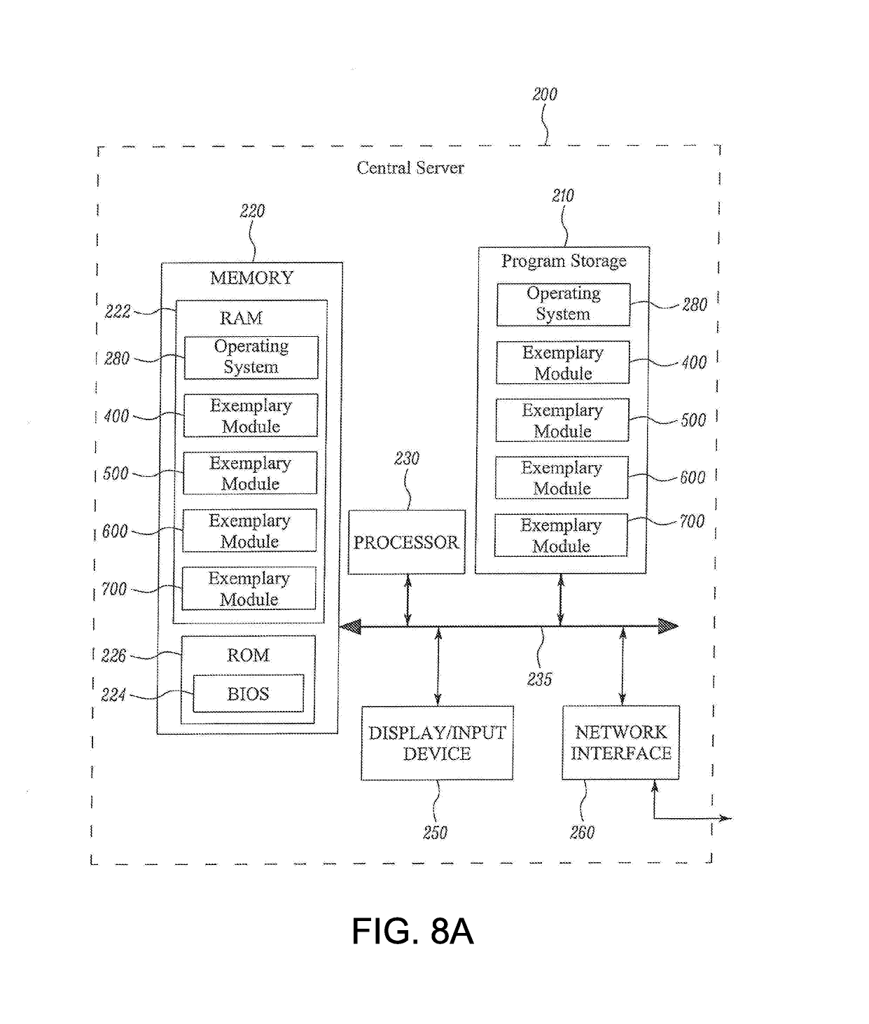

FIG. 7 is a block diagram of an exemplary system 320 that can be used in conjunction with various embodiments of the present invention. In at least the illustrated embodiment, the system 320 may include one or more central computing devices 110, one or more distributed computing devices 120, and one or more distributed handheld or mobile devices 300, all configured in communication with a central server 200 (or control unit) via one or more networks 130. While FIG. 7 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 320 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the device(s) 110-300 are illustrated in FIG. 7 as communicating with one another over the same network 130, these devices may likewise communicate over multiple, separate networks.

According to one embodiment, in addition to receiving data from the server 200, the distributed devices 110, 120, and/or 300 may be further configured to collect and transmit data on their own. In various embodiments, the devices 110, 120, and/or 300 may be capable of receiving data via one or more input units or devices, such as a keypad, touchpad, barcode scanner, radio frequency identification (RFID) reader, interface card (e.g., modem, etc.) or receiver. The devices 110, 120, and/or 300 may further be capable of storing data to one or more volatile or non-volatile memory modules, and outputting the data via one or more output units or devices, for example, by displaying data to the user operating the device, or by transmitting data, for example over the one or more networks 130.

In various embodiments, the server 200 includes various systems for performing one or more functions in accordance with various embodiments of the present invention, including those more particularly shown and described herein. It should be understood, however, that the server 200 might include a variety of alternative devices for performing one or more like functions, without departing from the spirit and scope of the present invention. For example, at least a portion of the server 200, in certain embodiments, may be located on the distributed device(s) 110, 120, and/or the handheld or mobile device(s) 300, as may be desirable for particular applications. As will be described in further detail below, in at least one embodiment, the handheld or mobile device(s) 300 may contain one or more mobile applications 330 which may be configured so as to provide a user interface for communication with the server 200, all as will be likewise described in further detail below.

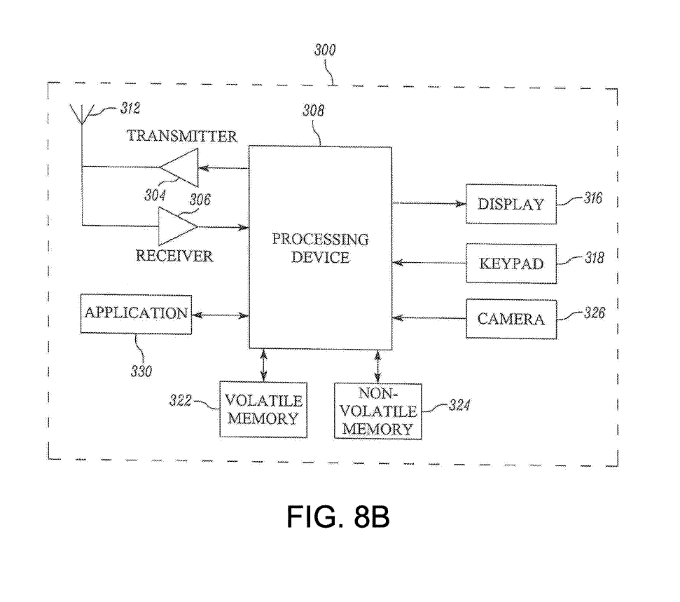

FIG. 8A is a schematic diagram of the server 200 according to various embodiments. The server 200 includes a processor 230 that communicates with other elements within the server via a system interface or bus 235. Also included in the server 200 is a display/input device 250 for receiving and displaying data. This display/input device 250 may be, for example, a keyboard or pointing device that is used in combination with a monitor. The server 200 further includes memory 220, which typically includes both read only memory (ROM) 226 and random access memory (RAM) 222. The server's ROM 226 is used to store a basic input/output system 224 (BIOS), containing the basic routines that help to transfer information between elements within the server 200. Various ROM and RAM configurations have been previously described herein.

In addition, the server 200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the system bus 235 by an appropriate interface. The storage devices 210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 210 and/or memory of the server 200 may further provide the functions of a data storage device, which may store historical and/or current delivery data and delivery conditions that may be accessed by the server 200. In this regard, the storage device 210 may comprise one or more databases. The term “database” refers to a structured collection of records or data that is stored in a computer system, such as via a relational database, hierarchical database, or network database and as such, should not be construed in a limiting fashion.

A number of program modules (e.g., exemplary modules 400-700) comprising, for example, one or more computer-readable program code portions executable by the processor 230, may be stored by the various storage devices 210 and within RAM 222. Such program modules may also include an operating system 280. In these and other embodiments, the various modules 400, 500, 600, 700 control certain aspects of the operation of the server 200 with the assistance of the processor 230 and operating system 280. In still other embodiments, it should be understood that one or more additional and/or alternative modules may also be provided, without departing from the scope and nature of the present invention.

In various embodiments, the program modules 400, 500, 600, 700 are executed by the server 200 and are configured to generate one or more graphical user interfaces, reports, instructions, and/or notifications/alerts, all accessible and/or transmittable to various users of the system 320. In certain embodiments, the user interfaces, reports, instructions, and/or notifications/alerts may be accessible via one or more networks 130, which may include the Internet or other feasible communications network, as previously discussed.

In various embodiments, it should also be understood that one or more of the modules 400, 500, 600, 700 may be alternatively and/or additionally (e.g., in duplicate) stored locally on one or more of the devices 110, 120, and/or 300 and may be executed by one or more processors of the same. According to various embodiments, the modules 400, 500, 600, 700 may send data to, receive data from, and utilize data contained in one or more databases, which may be comprised of one or more separate, linked and/or networked databases.

Also located within the server 200 is a network interface 260 for interfacing and communicating with other elements of the one or more networks 130. It will be appreciated by one of ordinary skill in the art that one or more of the server 200 components may be located geographically remotely from other server components. Furthermore, one or more of the server 200 components may be combined, and/or additional components performing functions described herein may also be included in the server.

While the foregoing describes a single processor 230, as one of ordinary skill in the art will recognize, the server 200 may comprise multiple processors operating in conjunction with one another to perform the functionality described herein. In addition to the memory 220, the processor 230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

FIG. 8B provides an illustrative schematic representative of a mobile device 300 that can be used in conjunction with various embodiments of the present invention. Mobile devices 300 can be operated by various parties. As shown in FIG. 8B, a mobile device 300 may include an antenna 312, a transmitter 304 (e.g., radio), a receiver 306 (e.g., radio), and a processing element 308 that provides signals to and receives signals from the transmitter 304 and receiver 306, respectively.

The signals provided to and received from the transmitter 304 and the receiver 306, respectively, may include signaling data in accordance with an air interface standard of applicable wireless systems to communicate with various entities, such as the server 200, the distributed devices 110, 120, and/or the like. In this regard, the mobile device 300 may be capable of operating with one or more air interface standards, communication protocols, modulation types, and access types. More particularly, the mobile device 300 may operate in accordance with any of a number of wireless communication standards and protocols. In a particular embodiment, the mobile device 300 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 300 can also download changes, add-ons, and updates, for instance, to its firmware, software (e.g., including executable instructions, applications, program modules), and operating system.

According to one embodiment, the mobile device 300 may include a location determining device and/or functionality. For example, the mobile device 300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 300 may also comprise a user interface (that can include a display 316 coupled to a processing element 308) and/or a user input interface (coupled to a processing element 308). The user input interface can comprise any of a number of devices allowing the mobile device 300 to receive data, such as a keypad 318 (hard or soft), a touch display, voice or motion interfaces, or other input device. In embodiments including a keypad 318, the keypad can include (or cause display of) the conventional numeric (0-9) and related keys (#, *), and other keys used for operating the mobile device 300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 300 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 300.

The mobile device 300 may also include one or more of a camera 326 and a mobile application 330. The camera 326 may be configured according to various embodiments as an additional and/or alternative data collection feature, whereby one or more items may be read, stored, and/or transmitted by the mobile device 300 via the camera. The mobile application 330 may further provide a feature via which various tasks may be performed with the mobile device 300. Various configurations may be provided, as may be desirable for one or more users of the mobile device 300 and the system 320 as a whole.

The invention is not limited to the above-described embodiments and many modifications are possible within the scope of the following claims. Such modifications may, for example, involve using a different source of energy beam than the exemplified electron beam such as a laser beam. Other materials than metallic powder may be used, such as the non-limiting examples of: electrically conductive polymers and powder of electrically conductive ceramics. Images taken from more than 2 layers may also be possible, i.e., in an alternative embodiment of the present invention for detecting a defect at least one image from at least three, four or more layers are used. A defect may be detected if the defect position in the three, four or more layers are at least partly overlapping each other. The thinner the powder layer the more powder layers may be used in order to detect a factual defect.

Indeed, a person of ordinary skill in the art would be able to use the information contained in the preceding text to modify various embodiments of the invention in ways that are not literally described, but are nevertheless encompassed by the attached claims, for they accomplish substantially the same functions to reach substantially the same results. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

1. A seal (19) for sealing against powder between a cylinder (14) of a build tank (5) and a build table (9) arranged in the cylinder of an additive manufacturing apparatus (1) for forming a three-dimensional article layer by layer from a powder, the seal (19) comprising an endless ring portion (21) for extending along a circumference of an inner surface (20) of the cylinder (14) and abutting against the inner surface (20).

2. A seal according to claim 1, wherein the ring portion forms a flexible flange (21) having an outer peripheral edge (23) for abutting against the inner surface (20) of the cylinder (14).

3. A seal according to claim 2, wherein the flange (21) is tapered with a decreasing thickness (28) towards the outer peripheral edge (23).

4. A seal according to claim 2, wherein the outer peripheral edge (23) of the flange (21) has a radius R in the range 0<R<100 μm.

5. A seal according to claim 2, wherein the outer peripheral edge (23) of the flange (21) has a radius R in the range 0<R<50 μm.

6. A seal according to claim 2, wherein the flange (21) has a length (27) in a radial direction of the flange and a thickness (28), the radial length of the flange being 10-200 times the flange thickness.

7. A seal according to claim 1, wherein the ring portion (21) is conical with a first end (29) for sealing against the inner surface (20) of the cylinder (14), and a second end (30), the first end having an outer dimension (22) exceeding an outer dimension (31) of the second end.

8. A seal according to claim 1, wherein the ring portion (21) is made of a metal material.

9. A seal according to claim 8, wherein the metal material is titanium or aluminium.

10. A build tank (5) for an additive manufacturing apparatus (1) for forming a three-dimensional article layer by layer from a powder, the build tank (5) comprising:
a cylinder (14); and
a build table (9) arranged inside the cylinder, which build table is displaceable relative to the cylinder in an axial direction (16) of the cylinder, the build table (9) dividing the cylinder in an upper space (17) and a lower space (18) and having a surface (10) facing towards the upper space for receiving powder,
wherein:
the build tank (5) further comprises a seal (19) mechanically connected to the build table (9) for sealing between an inner surface (20) of the cylinder (14) and the build table (9), so as to prevent powder from being moved from the upper space (17) to the lower space (18), and
the seal (19) has an endless ring portion (21) extending along a circumference of the inner surface (20) and abutting against the inner surface (20) of the cylinder (14).

11. A build tank according to claim 10, wherein an outer dimension (22) of the ring portion (21) exceeds an inner dimension (15) of the cylinder (14) before the seal (19) is arranged in the cylinder (14) such that the ring portion (21) is compressed and pre-tensioned when the seal (19) is arranged in the cylinder (14).

12. A build tank according to claim 11, wherein the outer dimension is an outer diameter (22) of the ring portion (21) and the inner dimension is an inner diameter (15) of the cylinder (14), the outer diameter (22) of the ring portion (21) being 1.0005 to 1.02 times the inner diameter (15) of the cylinder (14) before the seal (19) is arranged in the cylinder.

13. A build tank according to claim 11, wherein the outer dimension is an outer diameter (22) of the ring portion (21) and the inner dimension is an inner diameter (15) of the cylinder (14), the outer diameter (22) of the ring portion (21) being 1.001 to 1.01 times the inner diameter (15) of the cylinder (14) before the seal (19) is arranged in the cylinder.

14. A build tank according to claim 10, wherein the seal (19) is mechanically connected to the build table (5) such that the seal will follow a displacement motion of the build table in the axial direction (16) of the cylinder (14), and such that the seal (19) is floating relative to the build table in a radial direction (24) of the cylinder (14) for centring the ring portion (21) relative to the cylinder by the inner surface (20) of the cylinder.

15. A build tank according to claim 10, wherein the ring portion forms a flexible flange (21) protruding from the build table (5), the flange having an outer peripheral edge (23) abutting against the inner surface (20) of the cylinder (14).

16. A build tank according to claim 15, wherein the flange (21) is angled relative to a radial direction (24) of the cylinder (14) such that in a radial direction along the flange towards the outer peripheral edge (23), the flange has a first extension direction component (25) in parallel with the radial direction (24) of the cylinder which first direction component points towards the inner surface (20) of the cylinder (14), and a second direction component (26) in parallel with the axial direction (16) of the cylinder which second direction component points upwards.

17. A build tank according to claim 16, wherein the flange (21) forms an angle α relative to the radial direction (24) of the cylinder (14), where α is in the range 30′<α<90°.

18. A build tank according to claim 16, wherein the flange (21) forms an angle α relative to the radial direction (24) of the cylinder (14), where α is in the range 45°<α<90°.

19. A seal according to claim 15, wherein the flange (21) is tapered with a decreasing thickness (28) towards the outer peripheral edge (23).

20. A build tank according to claim 15, wherein the outer peripheral edge (23) of the flange (21) has a radius R in the range 0<R<100 μm.

21. A build tank according to claim 15, wherein the outer peripheral edge (23) of the flange (21) has a radius R in the range 0<R<50 μm.

22. A build tank according to claim 15, wherein the flange (21) has a length (27) in a radial direction of the flange and a thickness (28), the radial length of the flange is 10-200 times the flange thickness.

23. A build tank according to claim 10, wherein the ring portion (21) is conical and has a first end (29) with a first outer dimension (22) of the ring portion, and a second end (30) with a second outer dimension (31) being smaller than the first outer dimension (22), the conical ring portion (21) being arranged in the cylinder (14) with the first end (29) facing upwards and the second end (30) facing downwards.

24. A build tank according to claim 10, wherein the ring portion (21) is made of a metal material.

25. A build tank according to claim 24, wherein the ring portion (21) is made of titanium or aluminium.

26. A computer program product comprising at least one non-transitory computer-readable storage medium having computer-readable program code portions embodied therein, the computer-readable program code portions comprising one or more executable portions configured for:
selectively controlling, via a control unit, displacement of a build table (9) arranged inside a cylinder (14) of a build tank (5), the build table dividing the cylinder into an upper space (17) and a lower space (18), the cylinder having an inner surface (20),
maintaining, during the displacement of the build table (9) and resulting changes in volumes of the upper space (17) and the lower space (18), separation of powder in each of the upper space (17) and the lower space (18), the separation being maintained via a seal (19) mechanically connected to the build table (9) and having an endless ring portion (21) extending along a circumference of the inner surface (20) and abutting against the inner surface of the cylinder (14).
